(19) United States
(12) Patent Application Publication
(10) Pub. No.: US 2023/0367647 A1
(43) Pub. Date: Nov. 16, 2023

(54) METHOD FOR ADAPTIVE RESOURCE ALLOCATION FOR APPLICATIONS IN A DISTRIBUTED SYSTEM OF HETEROGENEOUS COMPUTE NODES

(71) Applicant: Robert Bosch GmbH, Stuttgart (DE)

(72) Inventors: Arne Hamann, Ludwigsburg (DE); Dakshina Narahari Dasari, Boeblingen (DE); Dirk Ziegenbein, Freibrg Am Neckar (DE); Michael Pressler, Karlsruhe (DE)

(21) Appl. No.: 18/186,514

(22) Filed: Mar. 20, 2023

(30) Foreign Application Priority Data
May 13, 2022 (DE) 10 2022 204 718.4

(51) Int. Cl. G06F 9/50

(52) U.S. Cl. CPC G06F 9/5072; G06F 9/5088

(57) ABSTRACT

A method for adaptive resource allocation for applications in a distributed system of heterogeneous compute nodes. The following adaptation steps are carried out repeatedly and in an automated manner by an allocation and migration unit at least partially during a runtime of the applications: carrying out monitoring of the applications and the resources of the system to ascertain a need for changes of a resource allocation of the resources of the system for the applications; adapting the resource allocation based on the ascertained need for changes.

### CROSS REFERENCE

The present application claims the benefit under 35 U.S.C. § 119 of German Patent Application No. DE 10 2022 204 718.4 filed on May 13, 2022, which is expressly incorporated herein by reference in its entirety.

### FIELD

The present invention relates to a method for adaptive resource allocation for applications in a distributed system of heterogeneous compute nodes. Furthermore, the present invention relates to a computer program and a compute node for this purpose.

### BACKGROUND INFORMATION

It is fundamentally understood from the related art that a distributed system of compute nodes may be used for executing applications. It is possible in this case that the compute nodes are heterogeneous and the applications thus have to be able to be mapped on the heterogeneous compute nodes having different computing capacities. This may be relevant, for example, for computing centers on location, for cloud applications, and for the distribution of embedded applications on a heterogeneous SoC (system-on-a-chip) having different computing capacities. In many applications, which are provided in the cloud, it may be important to find the best compute nodes in a cluster on which the application is to be provided. In edge computing applications, it is often important to functionally divide an application and to distribute parts of the application to the edge devices and a part of the application to the cloud. In addition, in edge computing applications-in contrast to cloud computing applications including a cluster of homogeneous nodes there is the additional challenge for a mapping in dealing with the heterogeneity of the devices and the heterogeneity of the applications.

Uncontrolled mapping may result in a suboptimal performance of the application. Moreover, it is a challenge that some applications have a high degree of parallelism, others follow the dataflow semantics, are purely sequential, or may be a mixed form of the above-mentioned forms. The provided applications may also have different resource requirements. For example, these may be requirements for the computing power, the memory, the network, and other input and output resources. The compute nodes may be heterogeneous and the applications may not be independent, since they communicate with other applications via messages in the communication channel.

The related art generally provides static mapping, which may result in suboptimal utilization of the resources and suboptimal performance of the application.

Furthermore, scheduling solutions exist which are able to dynamically assign applications. However, these are not used in the case of heterogeneous compute nodes, but rather primarily on node clusters in computing centers including homogeneous compute node structure. In addition, an execution sequence of various applications on the planned compute nodes often remains unconsidered in this case. Moreover, these solutions are used for providing stateless, independent applications (and not for applications which interact with one another) and they do not take into consideration network latency. Conventional approaches therefore have only limited insight into the resource consumption profile of the application and often do not take these factors into consideration in the mapping.

### SUMMARY

The present invention is directed to a method, a computer program, and a compute node. Further features and details of the present invention result from the disclosure herein. Features and details which are described herein in conjunction with the method according to the present invention also apply in conjunction with the computer program according to the present invention and the compute node according to the present invention, and vice versa in each case, so that mutual reference always is or may be made to the individual aspects of the present invention with respect to the disclosure.

The method according to the present invention may be provided for adaptive resource allocation for applications in a distributed system of heterogeneous compute nodes. The compute nodes are preferably heterogeneous in that they include different computing capacities and/or different functionalities and/or different types of hardware. The heterogeneous compute nodes may also be designed as at least one of the following device categories:
different small IoT devices (IoT stands for “Internet of Things”),
different telephones,
different cloud servers, which provide different performances, for example,
different compute nodes in edge computing, for example including a data processing device in a vehicle and a data processing device outside the vehicle,
different computing capacities in a SoC,
different processors,
different computing capacities, such as all-purpose or special floating-point or graphics processing or acceleration capacities.

It is thus also possible that the distributed system includes distributed middleware and/or various operating systems or hypervisors and/or an edge computing environment and/or an IoT environment and/or a cloud computing environment and/or a vehicle controller. It is also optionally possible that the compute nodes are designed as at least partially mobile, and thus move while the method according to the present invention is carried out.

In addition to the compute nodes, the communication resources and/or the applications may also be heterogeneous, thus provide or require differing performance. The method is thus preferably particularly suitable to be used for a heterogeneous environment. Furthermore, the applications may also be heterogeneous and/or also designed as an application container. The computing capacity may furthermore be a computing power which a compute node provides for execution of the application.

Furthermore, it is possible that at least partially during a run time of the applications, i.e., in particular while the applications are being executed and are active, according to an example embodiment of the present invention the following adaptation steps are carried out repeatedly and/or in an automated manner, preferably by an allocation and migration unit:
carrying out monitoring of the applications and/or of resources of the system to ascertain a need for changes of a resource allocation of the resources of the systems for the applications. This step may also be referred to as “run time monitoring. ”
adapting, in particular changing, the resource allocation on the basis of the ascertained need for changes. This step may also be referred to as “mapping. ”

Carrying out the adaptation steps in ongoing operation of the applications may result in a more efficient, resilient, robust, and reliable system and may moreover increase the overall performance of the system. A resource allocation may be understood as both the allocation of resources to the applications and also the allocation of applications to the resources. The resources may include in this case, for example, computing and communication resources. Moreover, the so-called “mapping” is also referred to as allocation or assignment within the scope of the present invention. Furthermore, a resource allocation may preferably be understood as a configuration of the resources to be allocated or already as an implementation of the resource allocation.

A further special feature in the method according to an example embodiment of the present invention may moreover be that the monitoring is carried out as monitoring of both the applications and the resources of the system to ascertain the need for changes. In contrast to conventional approaches, therefore not only changes of the resources such as hardware failures may be detected, but a changed resource demand of the applications may also be ascertained.

The method according to an example embodiment of the present invention may carry out the resource allocation dynamically, for example assign incoming applications dynamically to a desired compute node and dynamically plan an execution sequence of the applications. One challenge in the assignment is possibly that it is difficult or even impossible to predict the resource requirements statically or at the time of design. Static mapping is thus often not practical for systems which change and refine dynamically on the application and topology level. There is therefore a need for an approach to be able to bypass the varying resource requirements such as a data-dependent resource demand of applications. The approach according to the present invention has the advantage, for example, that down-times of compute nodes and varying resource availability (defective network connections, failed compute nodes) are handled better.

Furthermore, according to an example embodiment of the present invention, it is possible that the following steps are carried out prior to and/or not at the run time of the applications and prior to the adaptation steps:
ascertaining a static resource profile of the applications and/or of the resources to initially define a resource requirement of the applications,
initially determining the resource allocation on the basis of the defined resource requirement.

According to an example embodiment of the present invention, at least one of the following steps may be carried out to provide the static resource profile:
recognizing a use of parallel processing or floating-point operations of the applications,
extracting a degree of a parallelism of the applications,
recognizing memory and/or computing and/or input and output requirements of the applications.

Code analyses and/or technologies of machine learning, for example, may be used for the above-mentioned steps. Alternatively, user-specific adaptations of the resource profile may also take place. An analysis for ascertaining the static resource profile may also take place, in which the applications are executed in isolation on individual compute nodes and analyzed.

In addition, according to an example embodiment of the present invention, it may be provided that prior to a run time of the applications, a hardware analysis is carried out to ascertain the static resource profile and/or initially determine the resource allocation. This may include ascertaining at least one hardware feature, for example a number of kernels of the compute nodes and/or a type of the kernels and/or a processing speed of the compute nodes and/or a memory hierarchy and/or the like. In addition, a network topology of the network may possibly be ascertained with the aid of classic network recognition, to establish how the compute nodes are distributed in the network. Pieces of information such as the bandwidth via various communication links in the network may also optionally be detected. The communication links are used in this case in the network for communication of the applications with one another.

It may furthermore be possible that the heterogeneous compute nodes have different computing capacities, the adaptation of the resource allocation being able to include the following step, in which in particular the resource allocation is actively changed:
assigning the applications and/or of subprocesses of the applications to the heterogeneous compute nodes in order to execute the applications and/or the subprocesses as a function of the ascertained need for changes using the different computing capacity.

The computing capacity may thus be a resource which may be allocated to the applications. The computing capacity may determine with which performance the applications may be executed. The resource allocation is thus dependent on the resource requirements of the applications. A change of the resource requirements during the run time may thus be taken into consideration effectively by the dynamic resource allocation. For this purpose, the assignment may possibly also be changed dynamically during the run time.

According to a further advantage of the present invention, it may be provided that the system includes different communication resources, the adaptation of the resource allocation including the following step:
assigning the communication resources for the applications as a function of the ascertained need for changes.

The communication resources may also be executed heterogeneously, and thus, for example, may be based on different types of hardware or have a different structure. For example, the communication resources may include an array of hard-wired and/or wireless network connections which accordingly offer different bandwidths. In addition, the bandwidth may not be constant in the case of wireless network connections. Depending on the positioning and/or movement in the network by the compute nodes, if these are mobile compute nodes, and/or interfering mobile objects, the bandwidth may thus be variable. The performance of the communication of the applications with one another is dependent in this case on communication resources allocated to the applications. A change of the resource requirements during the run time may thus also be taken into consideration effectively hereby due to the dynamic resource allocation.

It may advantageously be provided within the scope of the present invention that carrying out the monitoring of the applications includes at least one of the following steps:
detecting resource requirements varying during the run time, in particular data-dependent resource requirements, of the applications for ascertaining the need for changes,
detecting applications entering and/or leaving the system during the run time to ascertain the need for changes.

It is thus possible to deal with the varying resource requirements of applications, for example, due to the varying data demand and/or due to a resource demand dependent on mode and/or situation and/or context. A need for changes is accordingly ascertained in this case which originates from the applications. The resource requirements may therefore also be referred to as a resource demand, which may correspond to a demand originating from the applications for required resources for executing and/or ensuring a correct function and/or meeting a latency requirement.

It is moreover advantageous if carrying out the monitoring of the resources of the system includes the following step:
detecting resources of the system varying during the run time, in particular an entry and/or exit of compute nodes and/or a reduction or increase of a computing capacity and/or a failure of at least one communication resource, for ascertainment of the need for changes. A need for changes is accordingly ascertained in this case which originates from the resources.

A further advantage may be achieved within the scope of the present invention if the adaptation steps and in particular the monitoring and/or the adapting of the resource allocation include at least one of the following steps, which are preferably executed by the allocation and migration unit:
recognizing and in particular recording a change of a resource requirement of an application and/or migrating the application having the changed resource requirement adaptively to one of the compute nodes which is designed to meet the changed resource requirement,
recognizing and in particular recording when a load on at least one of the compute nodes exceeds a predefined threshold value, in particular over a predefined duration, a migration of at least one application, which is executed on the at least one compute node, then preferably taking place,
adapting the resource allocation on one of the compute nodes on which an application having a changed resource requirement is executed,
recording a performance of the applications on various ones of the compute nodes to ascertain an optimized resource allocation in order to carry out the adaptation of the resource allocation on the basis of the optimized resource allocation.

The migration, thus in particular a software migration, is advantageously to be understood to mean that the provided application is transferred into a new technological environment, for example, of another compute node. In addition, still further measures such as resource allocation and scheduling are possible in order to optimize the execution of the applications.

According to an example embodiment of the present invention, it may be provided that the adaptation steps and in particular the monitoring and/or the adaptation of the resource allocation include at least one of the following steps, which are preferably carried out by the allocation and migration unit (Mapping and Migration Engine, abbreviated as MME):
for at least one or each application, a ranking of the compute nodes best suitable for the execution may be created and updated and the application may be allocated to the best suitable compute node,
for each set of communicating applications, the MME may execute various assignments of applications to compute nodes in order to provide a compromise between optimum application assignment and communication latencies. Various heuristics and/or machine learning technologies may be used for this purpose. Thus, for example, initially the optimum application assignment may be selected and subsequently it may be checked whether the communication latency is acceptable. Alternatively, communication-centered mapping may also be carried out. Methods which take into consideration both the communication and the application mapping at the same time are also applicable (for example, heuristics or machine learning-based approaches).
The vitality of a topology of the network may be checked regularly to discover failed compute nodes or connections by sending heartbeat messages.

Furthermore, according to an example embodiment of the present invention, it may be provided within the scope of the present invention that a scheduling unit (abbreviated as SE or “scheduling engine”) is executed on one or each of the compute nodes, which preferably repeatedly exchanges with the allocation and migration unit during the run time at least one piece of information about a present availability of at least one resource of the system and/or the compute node on which it is executed, and/or the resource requirement, and/or the ascertained need for changes, in order to preferably define an execution sequence of applications. A scheduling may be provided by a scheduling unit, thus in particular the chronological execution sequence of the applications or its subprocesses are defined and/or controlled. As soon as an application has been assigned by the resource allocation and preferably by the mapping to a compute node, it may be provided that the priority in the execution sequence of the applications on the compute node is also decided by the scheduling unit. It may be ensured if necessary that the applications meet their temporal requirements.

It may also be provided that multiple applications are mapped on the same compute node, so that it is necessary to control the execution sequence. The scheduling unit may be executed for this purpose on the corresponding compute node and/or each compute node. Furthermore, the scheduling unit may regularly interact with the MME in that it exchanges pieces of information which are used by the MME to make assignment decisions. These may be simple metrics such as the processor utilization or more complex metrics which are based on formal scheduling analyses and/or machine learning-based technologies and specify how many workloads may be housed without infringing the real-time restrictions. The SE may furthermore interact with the MME in order to understand the resource requirements of the application. The SE may then be responsible for the dynamic decision about the execution sequence and the planning parameters of the applications on the given compute node, in such a way that each application meets its real-time requirements. In addition, an SE which offers an advanced scheduler (including reservation-based scheduling) may also offer the applications guaranteed execution budgets for each preconfigured time period. This may be used by the MME in order to map applications which require a predictable performance and temporal isolation on certain compute nodes.

It is furthermore possible that the applications are executed as applications, which preferably communicate with one another, of distributed middleware and/or an operating system of a vehicle and/or an edge computing system and/or a cloud computing system and/or a vehicle controller. Furthermore, it is possible that the applications are also executed as an application container. In particular in the mentioned application fields, dynamic resource allocation offers advantages since heterogeneous compute nodes are used to a greater extent in distributed systems. Application containers are known in cloud and edge computing for containerization from the related art.

A computer program is also the subject matter of the present invention, in particular a computer program product including commands which, upon the execution of the computer program by a computer, prompt it to carry out the method according to the present invention. The computer program according to the present invention is thus accompanied by the same advantages as have been described in detail with reference to a method according to the present invention. A compute node of the network which executes the computer program, for example, in the form of a software module may be provided, for example, as the computer. The computer may include at least one processor for executing the computer program. A nonvolatile data memory may also be provided in which the computer program may be stored and from which the computer program may be read out by the processor for execution.

A computer-readable memory medium which includes the computer program according to the present invention may also be the subject matter of the present invention. The memory medium is designed, for example, as a data memory such as a hard drive and/or a nonvolatile memory and/or a memory card. The memory medium may be integrated, for example, in at least one or each compute node of the network.

In addition, the method according to the present invention may also be executed as a computer-implemented method.

A compute node configured for carrying out a method according to the present invention is also the subject matter of the present invention. The compute node according to the present invention is thus accompanied by the same advantages as have been described in greater detail with reference to a method according to the present invention. Further advantages, features, and details of the present invention result from the following description, in which the exemplary embodiments of the present invention are described in detail with reference to the drawings. The features disclosed herein may be essential to the present invention both individually or in arbitrary combination.

### BRIEF DESCRIPTION OF THE DRAWINGS

FIG. 1 schematically shows a sequence of a method according to an example embodiment of the present invention.

FIG. 2 schematically shows a structure of parts of a distributed system, according to an example embodiment of the present invention.

### DETAILED DESCRIPTION OF EXAMPLE EMBODIMENTS

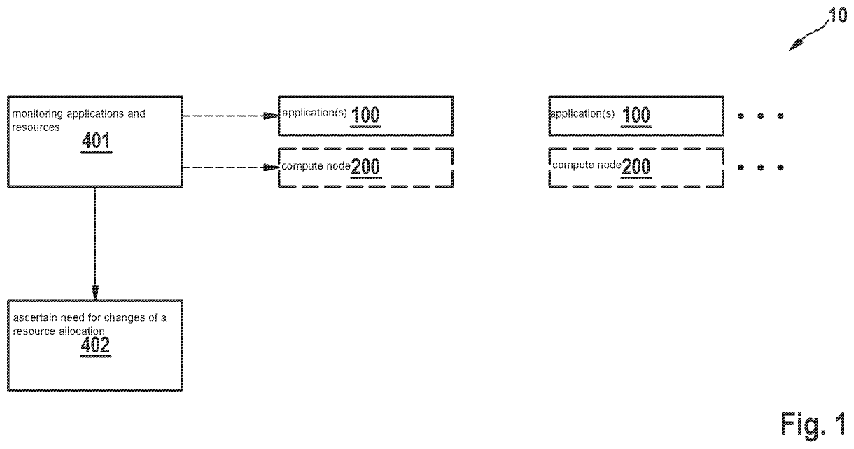

A method according to the present invention for adaptive resource allocation 402 for applications 100 in a distributed system 10 of heterogeneous compute nodes 200 is visualized in FIG. 1. It is provided in this case that the following adaptation steps are carried out repeatedly and in an automated manner by an allocation and migration unit 500 at least partially or completely during a runtime of applications 100. Initially, according to a first step, carrying out monitoring 401 of applications 100 and of resources of system 10 may be provided to ascertain a need for changes of a resource allocation 402 of the resources of system 10 for applications 100. The first step may also be referred to as online monitoring. The resource requirements of the executed applications may be dynamically updated and refined during the system run time in this way. According to a second step, an adaptation of resource allocation 402 may be carried out on the basis of the ascertained need for changes.

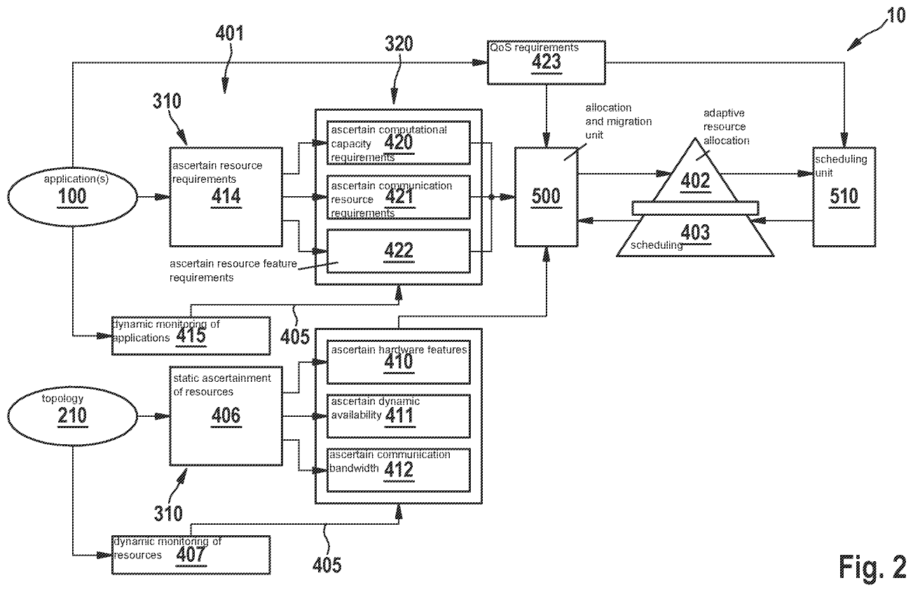

In addition, it is possible that prior to the run time of applications 100 and prior to the adaptation steps, a static resource profile 310 of applications 100 is ascertained, which is visualized in FIG. 2. Among other things, a resource requirement 320 of applications 100 may thus be initially defined. On the basis of (static/offline) pieces of design time information, a first good usage and system configuration may be derived therefrom as a “starting point. ” The initial determination of resource allocation 402 may then be carried out on the basis of defined resource requirement 320, possibly also prior to the run time of applications 100. Static pieces of information of resource profile 310 (which are obtained, for example, using methods of system technology) may thus be combined with pieces of information which are obtained during the online monitoring. In this way, it is possible to react to dynamic changes in the system (on the software and hardware level) and be able to give guarantees with respect to the design time specification and the requirements at the same time. Furthermore, it may be possible that computations and communication are taken into consideration jointly with the properties of distributed system 10 in resource allocation 402.

FIG. 2 also shows a structure in which an allocation and migration unit 500 and a scheduling unit 510 may carry out the shared adaptation steps at least partially. A scheduling unit 510 may thus be executed on at least one or each of compute nodes 200, which repeatedly exchanges with allocation and migration unit 500 during the run time at least one piece of information about a present availability of at least one resource of system 10 and/or compute node 200 on which it is executed, and/or resource requirement 320, and/or the ascertained need for changes, in order to define an execution sequence of applications 100. Scheduling unit 510 may carry out scheduling 403 if necessary on the operating system level. A hierarchical scheduling problem is thus solved: On the orchestration level and subsequently also on operating system level (i.e., which application thread is executed on which processor together with which execution sequence, for example, to meet time requirements).

In addition, various functional blocks are shown by way of example in FIG. 2, in order to implement the method according to the present invention. Prior to a run time of applications 100, i.e., “offline, ” a static ascertainment of resources 406, thus in particular in consideration of the hardware, and a static ascertainment of resource requirements 414 with respect to applications 100 may be carried out.

The static ascertainment of resource requirements 414 may possibly be carried out for all of N applications 100 which are provided in system 10. A result of this static ascertainment may subsequently be used for the static ascertainment of computational capacity requirements 420, of communication resource requirements 421, and of resource feature requirements 422 of applications 100. Computational capacity requirements 420 are, for example, requirements for a computing power of compute nodes 200. Communication resource requirements 421 include, for example, requirements for a communication bandwidth and/or speed. Resource feature requirements 422 include, for example, requirements for specific technical features of the hardware of compute nodes 200. It is optionally possible that this ascertainment is also subsequently carried out and refined online repeatedly and dynamically during a run time of applications 100, so that a dynamic adaptation 405 may be provided. The results of this ascertainment may be used for a definition of a resource requirement 320. Furthermore, QoS (quality of service) requirements 423 may also be taken into consideration for this purpose. A resource allocation 402 may subsequently be carried out therefrom by allocation and migration unit 500.

Furthermore, hardware features 410 and/or a dynamic availability 411 and/or a communication bandwidth 412, among other things, may be ascertained from the static ascertainment of resources 406. In contrast to resource requirements 414, this may relate to an actual state of the available hardware. These ascertained results may also be transferred to allocation and migration unit 500 and may be taken into consideration for resource allocation 402. Furthermore, a dynamic adaptation 405 during the runtime of applications 100 may also be provided for this ascertainment, by which later changes of the resources may be recognized.

In addition, a monitoring and profiling of applications 100 and topology 210 of the blocks “dynamic monitoring of the resources” 407 and “dynamic monitoring of the applications” 415 may be carried out separately at the runtime of applications 100 and used for adapting resource requirement 320. This refined specification of resource requirement 320 may then be fed continuously (or at predefined points in time or in the event of changes of a system state of system 10) into allocation and migration unit 500, which thus closes the feedback loop.

The method according to the present invention may furthermore be provided by a computer program 2, which is executed by a computer 200, such as a compute node 200.

The above explanation of the specific embodiments describes the present invention exclusively in the context of examples. Of course, individual features of the specific embodiments may be combined with one another freely, if technically reasonable, without departing from the scope of the present invention.

What is claimed is:

1. A method for adaptive resource allocation for applications in a distributed system of heterogeneous compute nodes, the method comprising:
carrying out the following adaptation steps repeatedly and in an automated manner by an allocation and migration unit at least partially during a runtime of the applications:
carrying out monitoring of the applications and of resources of the system to ascertain a need for changes of a resource allocation of resources of the system for the applications;
adapting the resource allocation based on the ascertained need for changes.

2. The method as recited in claim 1, wherein the following steps are carried out prior to the run time of applications and prior to the adaptation steps:
ascertaining a static resource profile of the applications in order to initially define a resource requirement of the applications, and
initially determining the resource allocation based on the defined resource requirement.

3. The method as recited in claim 1, wherein the heterogeneous compute nodes have different computing capacities, the adaptation of the resource allocation includes the following step:
assigning the applications and/or subprocesses of the applications to the heterogeneous compute nodes to execute the applications and/or the subprocesses as a function of the ascertained need for changes using the different computing capacity.

4. The method as recited in claim 1, wherein the system includes different communication resources, the adaptation of the resource allocation including the following step:
assigning the communication resources for the applications as a function of the ascertained need for changes.

5. The method as recited in claim 1, wherein the carrying out of the monitoring of the applications includes at least one of the following steps:
detecting data-dependent resource requirements of the applications varying during the runtime of the applications for ascertainment of the need for changes, and/or
detecting applications entering and/or leaving the system during the run time for ascertainment of the need for changes.

6. The method as recited in claim 1, wherein the carrying out of the monitoring of the resources of the system includes the following step:
detecting, for ascertainment of the need for changes, resources of the system varying during the runtime, including an entry and/or exit of compute nodes and/or a reduction or increase of a computing capacity and/or a failure of at least one communication resource.

7. The method as recited in claim 1, wherein the monitoring and/or the adaptation of the resource allocation include at least one of the following steps, which are executed by the allocation and migration unit:
recognizing and recording a change of a resource requirement of an application of the applications and migrating the application having the changed resource requirement adaptively to one of the compute nodes which is configured to meet the changed resource requirement,
recognizing and recording when a load on at least one of the compute nodes exceeds a predefined threshold value over a predefined duration, and migrating at least one of the applications, which is executed on the at least one of the compute nodes,
adapting the resource allocation on one of the compute nodes on which an application of the applications having a changed resource requirement is being executed,
recording a performance of the applications on various ones of the compute nodes to ascertain an optimized resource allocation to carry out the adaptation of the resource allocation based on the optimized resource allocation.

8. The method as recited in claim 7, wherein a scheduling unit is executed on at least one or each of the compute nodes, which repeatedly exchanges with the allocation and migration unit during the run time at least one piece of information to define an execution sequence of the applications, the at least one piece of information including information about:
a present availability of at least one of the resources of the system and/or the compute node on which it is executed, and/or
the resource requirement, and/or
the ascertained need for changes, to define an execution sequence of the applications.

9. The method as recited in claim 1, wherein the applications are configured as applications communicating with: one another of distributed middleware and/or an operating system of a vehicle and/or an edge computing system and/or a cloud computing system and/or a vehicle controller.

10. A non-transitory computer-readable medium on which is stored a computer program including an allocation and migration unit and including commands for adaptive resource allocation for applications in a distributed system of heterogeneous compute nodes, the commands, when executed by a computer, causing the computer to perform the following steps:
carrying out the following adaptation steps repeatedly and in an automated manner by the allocation and migration unit at least partially during a runtime of the applications:
carrying out monitoring of the applications and of resources of the system to ascertain a need for changes of a resource allocation of resources of the system for the applications;
adapting the resource allocation based on the ascertained need for changes.

11. A compute node configured for adaptive resource allocation for applications in a distributed system of heterogeneous compute nodes, the compute node configured to:
carry out the following adaptation steps repeatedly and in an automated manner by an allocation and migration unit at least partially during a runtime of the applications:
carrying out monitoring of the applications and of resources of the system to ascertain a need for changes of a resource allocation of resources of the system for the applications;
adapting the resource allocation based on the ascertained need for changes.
